(19) United States
(12) Patent Application Publication
(10) Pub. No.: US 2024/0319933 A1
(43) Pub. Date: Sep. 26, 2024

(54) INK JET SYSTEM

(71) Applicant: SEIKO EPSON CORPORATION, Tokyo (JP)

(72) Inventors: Toshiro MURAYAMA, SUWA-GUN FUJIMI-MACHI (JP); Nobuaki ITO, SUWA-SHI (JP); Tomonaga HASEGAWA, MATSUMOTO-SHI (JP); Akira MIYAGISHI, SHIOJIRI-SHI (JP)

(21) Appl. No.: 18/612,287

(22) Filed: Mar. 21, 2024

(30) Foreign Application Priority Data
Mar. 24, 2023 (JP) 2023-047874

(51) Int. Cl. G06F 3/12; B41J 2/21

(52) U.S. Cl. CPC G06F 3/121; B41J 2/2103; G06F 3/1234; G06F 3/1289

(57) ABSTRACT

An ink jet system includes a first recording apparatus in which at least a first head and a second head are mounted, a second recording apparatus in which at least a third head and a fourth head are mounted, and a processing apparatus that is commonly coupled to the first recording apparatus and the second recording apparatus and includes a display portion. The processing apparatus causes the display portion to display first state information indicating a state of the first head, second state information indicating a state of the second head, third state information indicating a state of the third head, and fourth state information indicating a state of the fourth head.

The present application is based on, and claims priority from JP Application Serial Number 2023-047874, filed Mar. 24, 2023, the disclosure of which is hereby incorporated by reference herein in its entirety.

### BACKGROUND

### 1. Technical Field

The present disclosure relates to an ink jet system.

### 2. Related Art

Recording apparatuses such as ink jet printers generally include a head that ejects a liquid such as ink as droplets. For example, JP-A-2021-84388 discloses a recording apparatus having an ink jet head.

JP-A-2021-84388 relates to a printer finished product model, which is a business model in which a head manufacturer that manufactures a head is incorporated in a recording apparatus, and the head manufacturer also manufactures and sells the recording apparatus. In contrast, in recent years, there has been a head external sales model, which is a business model in which a head manufacturer sells heads to a printer manufacturer, and the printer manufacturer manufactures a printer. In the head external sales model, the end user is either the printer manufacturer itself or the purchaser who purchased the printer from the printer manufacturer.

Here, depending on use, the head may deteriorate or errors such as ejection failure may occur. Since such errors occur after the head is sold, the head manufacturer cannot usually recognize the error. Therefore, the inventors devised a system in which the head manufacturer ascertains the use state of the ink, head, temperature and humidity, dot count, and the like in the heads owned by the end user through a cloud network, and notifies the end user of the presence or absence of occurrence of an error according to that use state. Providing this system in addition to the head thus provides added value to the printer manufacturer or end user over providing the head alone.

This system causes a processing apparatus such as a personal computer (PC) or a smartphone owned by the end user to display state information, which is information indicating which head is causing an error. In the previous studies, the inventors assumed one printer on which a plurality of heads are mounted, and did not assume a display based on a plurality of printers. Therefore, the inventors have found a method of displaying the state information that makes it easier to see when a plurality of printers are assumed.

### SUMMARY

According to an aspect of the present disclosure, there is provided an ink jet system including: a first recording apparatus in which at least a first head and a second head are mounted; a second recording apparatus in which at least a third head and a fourth head are mounted; and a processing apparatus that is commonly coupled to the first recording apparatus and the second recording apparatus and includes a display portion, in which the processing apparatus causes the display portion to display first state information indicating a state of the first head, second state information indicating a state of the second head, third state information indicating a state of the third head, and fourth state information indicating a state of the fourth head.

### BRIEF DESCRIPTION OF THE DRAWINGS

FIG. 1 is a schematic diagram showing a configuration example of an ink jet system according to an embodiment.

FIG. 2 is a schematic diagram showing a configuration example of a printer used in the ink jet system according to the embodiment.

FIG. 3 is a cross-sectional view showing a configuration example of a head chip.

FIG. 4 is a schematic diagram showing a configuration example of a processing apparatus used in the ink jet system according to the embodiment.

FIG. 5 is a schematic diagram showing a configuration example of a server used in the ink jet system according to the embodiment.

FIG. 6 is a flowchart showing processing between the processing apparatus and the server in the ink jet system according to the embodiment.

FIG. 7 is a flowchart showing display processing in the processing apparatus.

FIG. 8 is a diagram showing an example of a first display mode.

FIG. 9 is a diagram showing an example of a second display mode.

FIG. 10 is a diagram showing an example of a third display mode.

FIG. 11 is a diagram showing an example of a fourth display mode.

FIG. 12 is a diagram showing an example of a fifth display mode.

FIG. 13 is a diagram showing a display example when an ejection state from a first head is abnormal.

FIG. 14 is a diagram showing a display example of detailed state information of a head in a normal ejection state.

FIG. 15 is a diagram showing a display example of detailed state information of a head in an abnormal ejection state.

FIG. 16 is a diagram showing an example of a first display mode in Modification Example 1.

### DESCRIPTION OF EMBODIMENTS

Hereinafter, a preferred embodiment according to the present disclosure will be described with reference to the accompanying drawings. In the drawings, the dimensions and scale of each portion are appropriately different from the actual ones, and some portions are schematically shown for easy understanding. Further, the scope of the present disclosure is not limited to the embodiment unless it is stated in the following description that the present disclosure is particularly limited.

### 1. Embodiment

### 1-1. Overview of Ink Jet System

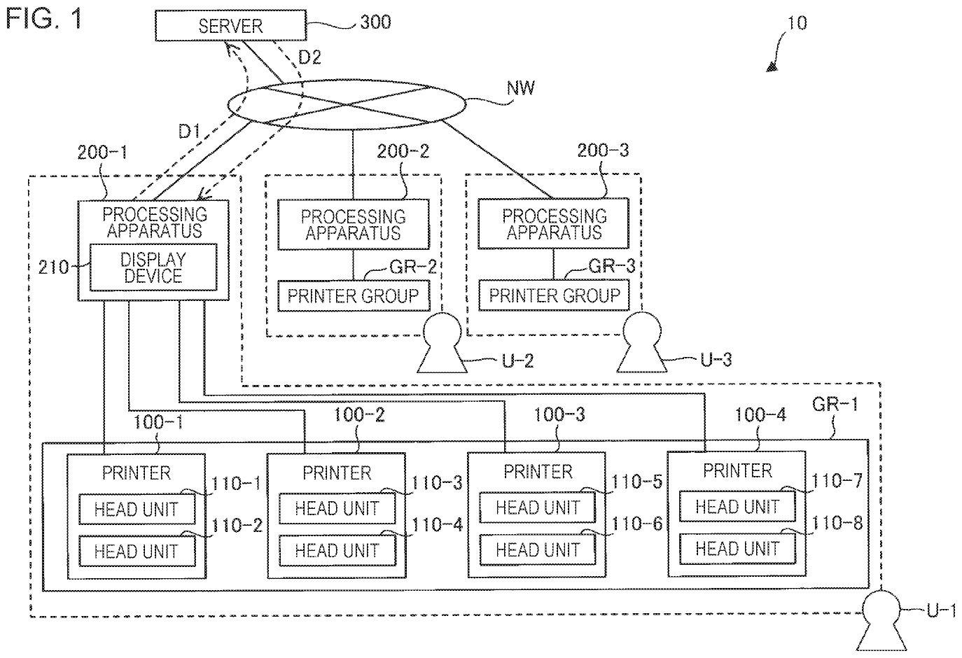

FIG. 1 is a schematic diagram showing a configuration example of an ink jet system 10 according to an embodiment. The ink jet system 10 is a system that performs printing using an ink jet method. In the example shown in FIG. 1, the ink jet system 10 includes printer groups GR-1 to GR-3, processing apparatuses 200-1 to 200-3, and a server 300.

The printer group GR-1 is a set of a plurality of printers used for a user U-1, the printer group GR-2 is a set of a plurality of printers used by a user U-2, and the printer group GR-3 is a set of a plurality of printers used by a user U-3. The printer groups GR-1 to GR-3 correspond to the processing apparatuses 200-1 to 200-3, respectively. The user U-1 uses the processing apparatus 200-1 in addition to the printers in the printer group GR-1. The user U-2 uses the processing apparatus 200-2 in addition to the printers in the printer group GR-2. The user U-3 uses the processing apparatus 200-3 in addition to the printers in the printer group GR-3.

In the following, without distinguishing each of printer groups GR-1 to GR-3, they may be referred to as the printer group GR. In the following, without distinguishing each of the users U-1 to U-3, they may be referred to as the user U.

In the following, without distinguishing each of the processing apparatuses 200-1 to 200-3, they may be referred to as the processing apparatus 200.

In the example shown in FIG. 1, the number of processing apparatuses 200 included in the ink jet system 10 is three, but the number is not limited thereto, and may be one, two, or four or more. That is, the number of sets of the processing apparatus 200 and the printer group GR is not limited to three, and may be one, two, or four or more.

In FIG. 1, for convenience of illustration, a configuration example of the printer group GR-1 among the printer groups GR-1 to GR-3 is shown as a representative example. In the example shown in FIG. 1, the printer group GR-1 is a set of the printers 100-1 to 100-4. The printer 100-1 is an example of a “first recording apparatus”, and the printer 100-2 is an example of a “second recording apparatus”. In the following, without distinguishing each of the printers 100-1 to 100-4, they may be referred to as the printer 100. The number of printers 100 included in the printer group GR may be two or more, and is not limited to the example shown in FIG. 1, but is optional. In addition, the number of printers 100 included in the printer groups GR-1 to GR-3 may be the same as or different from each other.

The printer 100-1 includes head units 110-1 and 110-2. The head unit 110-1 is an example of a “first head unit”. The head unit 110-2 is an example of a “second head unit”. The printer 100-2 includes head units 110-3 and 110-4. The head unit 110-3 is an example of a “third head unit”. The head unit 110-4 is an example of a “fourth head unit”. The printer 100-3 includes head units 110-5 and 110-6. The printer 100-4 includes head units 110-7 and 110-8. In the following, without distinguishing each of the head units 110-1 to 110-8, they may be referred to as the head unit 110.

Here, each of the printers 100-1 to 100-4 is provided by a printer manufacturer. The printer manufacturer is the one that manufactures the printers 100-1 to 100-4 using the head unit 110 purchased from a head manufacturer that manufactures the head unit 110. However, the printers in the printer groups GR-1 to GR-3 may be provided by the same manufacturer or may be provided by different manufacturers. In the following, without distinguishing each of the printers 100-1 to 100-4, they may be referred to as the printer 100. Furthermore, in the following, the manufacturer of the printer 100 may be simply referred to as a “printer manufacturer”, and the manufacturer of the head unit 110 or the liquid ejecting head 110a (described later) may be simply referred to as a “head manufacturer”. Further, among the elements constituting the printer 100, the elements other than the head unit 110 may be referred to as a “printer main body”.

When the printer manufacturer itself uses the printer 100, the printer manufacturer is the user U. When the printer manufacturer sells the printer 100 to a third party and the third party uses the printer 100, the third party is the user U.

Each of processing apparatuses 200-1 to 200-3 may use a property of the user U or may be provided by a printer manufacturer. For example, the user U-1 who uses the printers 100-1 to 100-4 owns the printers 100-1 to 100-4 and the processing apparatus 200-1. Here, the head unit 110 is incorporated in each of the printers 100-1 to 100-4, and the user U-1 also owns the head unit 110 incorporated in each of the printers 100-1 to 100-4. However, the head unit 110 is provided by the head manufacturer.

The server 300 may be any server as long as the head manufacturer can provide the necessary services to the user U, and may be owned by the head manufacturer itself, or by a third party other than the head manufacturer. Here, although the user U does not own the server 300, the processing apparatus 200 owned by the user U is communicatively connected to the server 300 through a communication network NW. When the server 300 is owned by a third party, a processing apparatus (not shown) owned by the head manufacturer itself is communicatively connected to the server 300 through the communication network NW. The processing apparatus is maintained and managed by the head manufacturer.

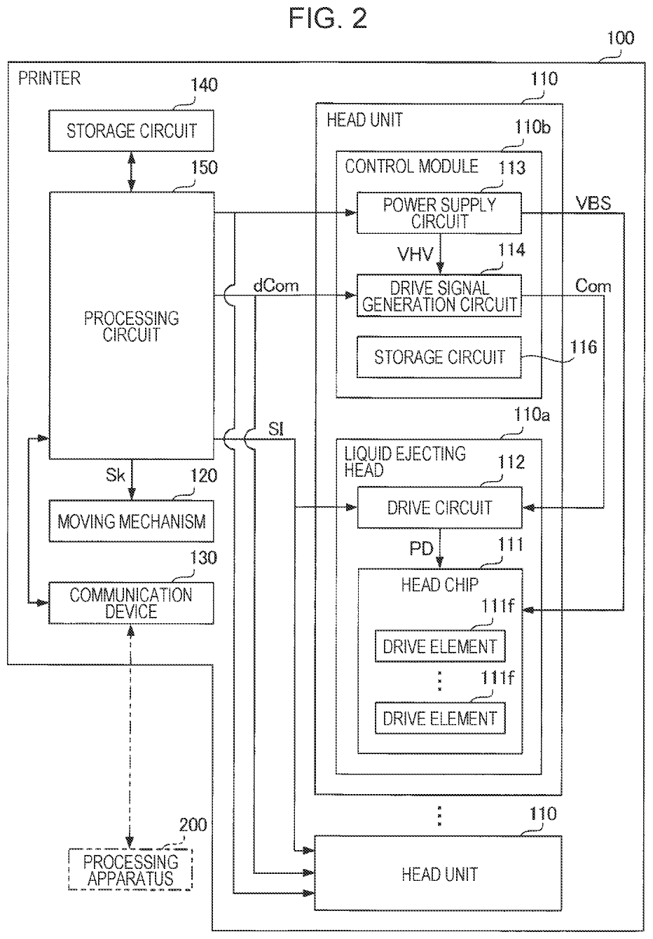

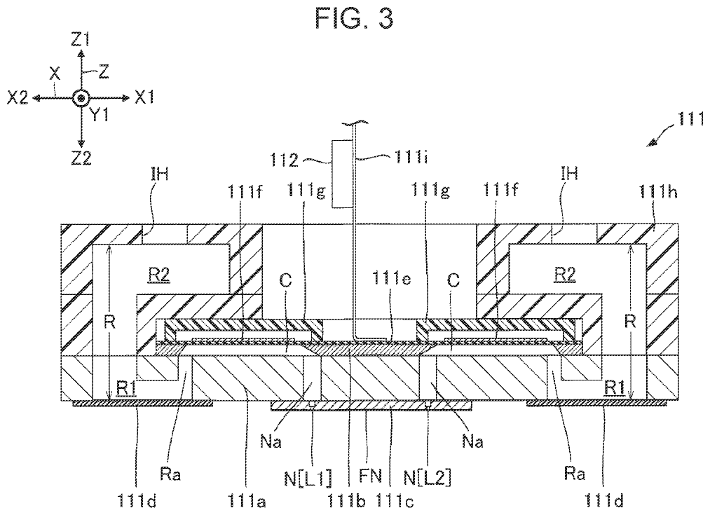

The printer 100 is communicatively connected to the processing apparatus 200, and is a printer that prints an image based on recorded data DP from the processing apparatus 200 on a print medium using an ink jet method. The recorded data DP is image data in a format that can be processed by the printer 100. The print medium may be any medium as long as it can be printed by the printer 100, and is not particularly limited, and is, for example, various papers, various cloths, various films, and the like. The printer 100 may be a serial type printer or a line type printer. A configuration of the printer 100 will be described in detail later with reference to FIGS. 2 and 3.

The processing apparatus 200 is a computer such as a smartphone, a tablet terminal, a desktop type, or a laptop type, and has a function of generating the recorded data DP, a function of controlling printing by the printer 100, and a function of acquiring necessary information from the printer 100. Here, the processing apparatus 200 generates the recorded data DP by performing various processing, such as raster image processor (RIP) processing or color conversion processing, on image data in the file format such as PostScript, a portable document format (PDF), and an XML paper specification (XPS).

Further, the processing apparatus 200 is communicatively connected to the server 300 through the communication network NW including the Internet, and has a function of outputting first information D1 to the server 300, a function of inputting second information D2 from the server 300, and a function of performing display based on the second information D2 in addition to the functions described above. The first information D1, which will be described in detail later, is information regarding the use state of the head. The second information D2, which will be described in detail later, is information regarding the state of the head.

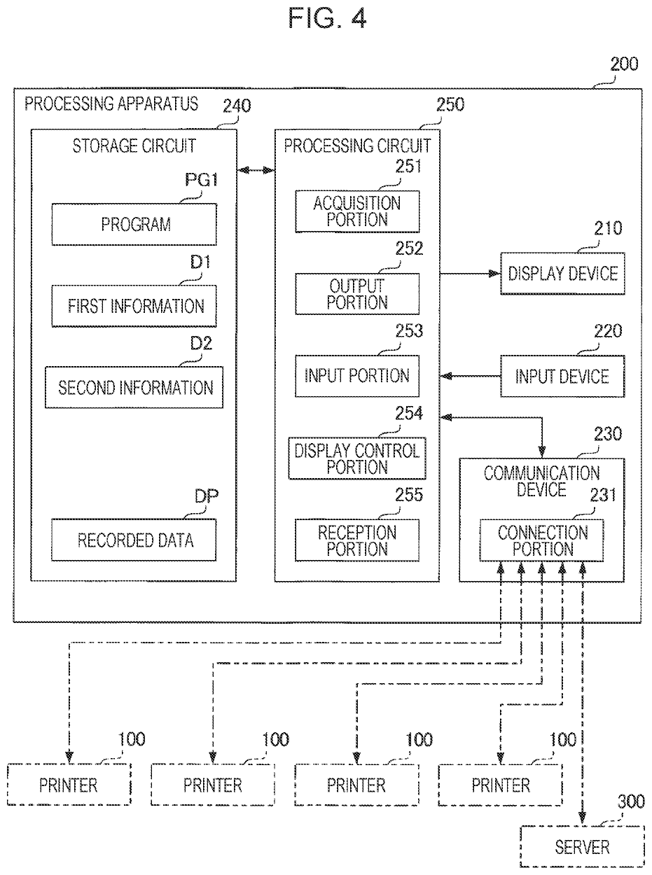

Here, the processing apparatus 200 includes a display device 210, and causes the display device 210 to display state information indicating the state of the plurality of heads at once in a manner that allows each printer 100 to be distinguished based on the second information D2. The display device 210 is an example of a “display portion”. A configuration of the processing apparatus 200 will be described in detail later with reference to FIG. 4.

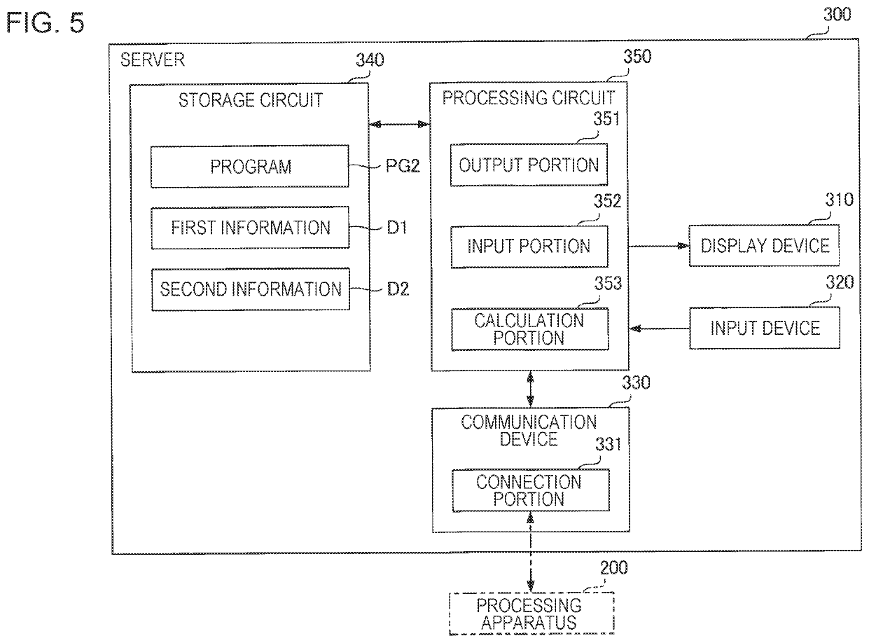

The server 300 is a computer that functions as a cloud server, and has a function of inputting the first information D1 from the processing apparatus 200 and a function of outputting the second information D2 according to the first information D1 to the processing apparatus 200. The configuration of the server 300 will be described in detail later with reference to FIG. 5.

As described above, the ink jet system 10 includes the printers 100-1 to 100-4 and the processing apparatus 200 that is commonly coupled to the printers 100-1 to 100-4 and that includes the display device 210. Here, as described above, at least the head unit 110-1 and the head unit 110-2 are mounted on the printer 100-1. At least the head unit 110-3 and the head unit 110-4 are mounted on the printer 100-2. At least the head unit 110-5 and the head unit 110-6 are mounted on the printer 100-3. At least the head unit 110-7 and the head unit 110-8 are mounted on the printer 100-4.

### 1-2. Printer Configuration

FIG. 2 is a schematic diagram showing a configuration example of the printer 100 used in the ink jet system 10 according to the embodiment. As shown in FIG. 2, the printer 100 includes a plurality of head units 110, a moving mechanism 120, a communication device 130, a storage circuit 140, and a processing circuit 150.

In the example shown in FIG. 2, for simplicity, the number of liquid ejecting heads 110a included in the head unit 110 is described as one, but in reality, the number is two or more. Specifically, in the present embodiment, one head unit 110 includes one liquid ejecting head 110a for cyan ink, one liquid ejecting head 110a for magenta ink, one liquid ejecting head 110a for yellow ink, and one liquid ejecting head 110a for black ink. However, it is not necessary to have one head 110a for each of the four colors. For example, there may be three heads 110a for each of the four colors. Furthermore, one head unit 110 may have heads 110a of three or fewer colors.

Although not shown in particular, the plurality of liquid ejecting heads 110a described above are integrally and detachably attached to the head unit 110.

The head unit 110 includes a head chip 111, a drive circuit 112, a power supply circuit 113, a drive signal generation circuit 114, and a storage circuit 116.

In the example shown in FIG. 2, the head unit 110 is divided into the liquid ejecting head 110a (also referred to as head 110a) including the head chip 111 and the drive circuit 112, and a control module 110b including the power supply circuit 113, the drive signal generation circuit 114, and the storage circuit 116. The head unit 110 is not limited to the aspect in which it is divided into the liquid ejecting head 110a and the control module 110b, and for example, a part or all of the control module 110b may be incorporated into the liquid ejecting head 110a.

The head chip 111 ejects ink toward the print medium. In FIG. 2, among the components of the head chip 111, a plurality of drive elements 111f are typically shown. A detailed example of the head chip 111 will be described later with reference to FIG. 3.

The drive circuit 112 performs switching under the control of the processing circuit 150 as to whether or not to supply the drive signal Com output from the drive signal generation circuit 114 to each of the plurality of drive elements 111f of the head chip 111 as a drive pulse PD. The drive circuit 112 includes, for example, a group of switches such as a transmission gate for the switching.

The power supply circuit 113 receives electric power from a commercial power source (not shown) and generates various predetermined potentials. The generated various potentials are appropriately supplied to each portion of the printer 100. In the example shown in FIG. 2, the power supply circuit 113 generates a power supply potential VHV and an offset potential VBS. The offset potential VBS is supplied to the head chip 111 and the like. Also, the power supply potential VHV is supplied to the drive signal generation circuit 114 and the like.

The drive signal generation circuit 114 is a circuit that generates a drive signal Com for driving each drive element 111f of the head chip 111. Specifically, the drive signal generation circuit 114 includes, for example, a digital-to-analog (DA) conversion circuit and an amplifier circuit. The drive signal generation circuit 114 generates the drive signal Com by the DA conversion circuit converting a waveform designation signal dCom described later from the processing circuit 150 from a digital signal to an analog signal, and the amplifier circuit amplifying the analog signal using the power supply potential VHV from the power supply circuit 113. Here, among the waveforms included in the drive signal Com, the signal of the waveform actually supplied to the drive element 111f is the drive pulse PD.

The storage circuit 116 is a semiconductor memory. The storage circuit 116 stores identification information and other information indicating a unique number such as a serial number unique to the head unit 110 or the liquid ejecting head 110a.

The moving mechanism 120 changes a relative position between the head unit 110 and the print medium. More specifically, when the printer 100 is a serial type, the moving mechanism 120 includes a transport mechanism for transporting the print medium in a predetermined direction and a moving mechanism for repeatedly moving the head unit 110 along an axis orthogonal to the transport direction of the print medium. Further, when the printer 100 is a line type, the moving mechanism 120 includes a transport mechanism for transporting the print medium in a direction intersecting a longitudinal direction of the elongated head unit 110.

The communication device 130 is a circuit capable of communicating with the processing apparatus 200. For example, the communication device 130 is a communication circuit having an interface such as a wireless or wired local area network (LAN) or a universal serial bus (USB). USB is a registered trademark. The communication device 130 may be connected to another processing apparatus 200 through another network such as the Internet.

The storage circuit 140 stores various programs executed by the processing circuit 150 and various types of data, such as the recorded data DP, processed by the processing circuit 150. The storage circuit 140 includes, for example, one or both semiconductor memories of one or more volatile memories such as random access memory (RAM) and one or more non-volatile memories such as read only memory (ROM), electrically erasable programmable read-only memory (EEPROM) or programmable ROM (PROM). The recorded data DP is supplied from, for example, the processing apparatus 200. The storage circuit 140 may be configured as a part of the processing circuit 150.

The processing circuit 150 has a function of controlling the operation of each portion of the printer 100 and a function of processing various types of data. The processing circuit 150 includes, for example, one or more processors such as a central processing unit (CPU). The processing circuit 150 may include a programmable logic device such as a field-programmable gate array (FPGA) instead of the CPU or in addition to the CPU.

The processing circuit 150 controls the operation of each portion of the printer 100 by executing a program stored in the storage circuit 140. Here, the processing circuit 150 generates signals such as a control signal Sk, a print data signal SI, and the waveform designation signal dCom as signals for controlling the operation of each portion of the printer 100.

The control signal Sk is a signal for controlling the driving of the moving mechanism 120 and is input to the moving mechanism 120. The print data signal SI is a signal for controlling the drive of the drive circuit 112, and is input to the drive circuit 112. Specifically, the print data signal SI designates whether or not the drive circuit 112 supplies the drive signal Com from the drive signal generation circuit 114 to the drive element 111f as a drive pulse PD, for each predetermined unit period. By this designation, the amount of ink ejected from the head chip 111 and the like are designated. The waveform designation signal dCom is a digital signal for defining the waveform of the drive signal Com generated by the drive signal generation circuit 114, and is input to the drive signal generation circuit 114.

FIG. 3 is a cross-sectional view showing a configuration example of the head chip 111. In the following description, for convenience of description, an X axis, a Y axis and a Z axis that intersect each other are appropriately used. In the following, one direction along the X axis is an X1 direction, and a direction opposite to the X1 direction is an X2 direction. Similarly, the directions opposite to each other along the Y axis are a Y1 direction and a Y2 direction. Opposite directions along the Z axis are a Z1 direction and a Z2 direction. The configuration of the head chip 111 is an example and is not limited to the example shown in FIG. 3.

As shown in FIG. 3, the head chip 111 has a plurality of nozzles N arranged in a direction along the Y axis. The plurality of nozzles N are divided into a first row L1 and a second row L2 which are arranged at intervals in a direction along the X axis. Each of the first row L1 and the second row L2 is a set of a plurality of nozzles N linearly arranged in the direction along the Y axis.

The head chip 111 has a configuration substantially symmetrical with each other in the direction along the X axis. However, positions of the plurality of nozzles N in the first row L1 and the plurality of nozzles N in the second row L2 in the direction along the Y axis may match or differ from each other. FIG. 3 illustrates a configuration in which the positions of the plurality of nozzles N in the first row L1 and the plurality of nozzles N in the second row L2 in the direction along the Y axis match with each other.

As shown in FIG. 3, the head chip 111 includes a flow path substrate 111a, a pressure chamber substrate 111b, a nozzle plate 111c, vibration absorbing bodies 111d, a vibration plate 111e, a plurality of drive elements 111f, protective plates 111g, a case 111h, and a wiring substrate 111i.

The flow path substrate 111a and the pressure chamber substrate 111b are stacked in this order in the Z1 direction, and form a flow path for supplying ink to a plurality of nozzles N. The vibration plate 111e, the plurality of drive elements 111f, the protective plates 111g, the case 111h, and the wiring substrate 111i are installed in a region located in the Z1 direction with respect to a stacked body formed by the flow path substrate 111a and the pressure chamber substrate 111b. On the other hand, the nozzle plate 111c and the Vibration absorbing bodies 111d are installed in a region located in the Z2 direction with respect to the stacked body. Each element of the head chip 111 is schematically a plate-shaped member elongated in the Y direction, and is joined to each other by, for example, an adhesive. Hereinafter, each element of the head chip 111 will be described in order.

The nozzle plate 111c is a plate-shaped member provided with a plurality of nozzles N in each of the first row L1 and the second row L2. Each of the plurality of nozzles N is a through hole through which ink is passed. Here, the surface of the nozzle plate 111c facing the Z2 direction is a nozzle surface FN. The nozzle plate 111c is manufactured by processing a silicon single crystal substrate by a semiconductor manufacturing technique using a processing technique such as dry etching or wet etching, for example. However, other known methods and materials may be appropriately used for manufacturing the nozzle plate 111c. Further, the cross-sectional shape of the nozzle is typically a circular shape, but the shape is not limited thereto, and may be a non-circular shape such as a polygon or an ellipse.

The flow path substrate 111a is provided with a space R1, a plurality of supply flow paths Ra, and a plurality of communication flow paths Na for each of the first row L1 and the second row L2. The space R1 is an elongated opening extending in the direction along the Y axis in a plan view in the direction along the Z axis. Each of the supply flow path Ra and the communication flow path Na is a through hole formed for each nozzle N. Each supply flow path Ra communicates with the space R1.

The pressure chamber substrate 111b is a plate-shaped member provided with a plurality of pressure chambers C referred to as cavities for each of the first row L1 and the second row L2. The plurality of pressure chambers C are arranged in the direction along the Y axis. Each pressure chamber C is an elongated space formed for each nozzle N and extending in the direction along the X axis in a plan view. Each of the flow path substrate 111a and the pressure chamber substrate 111b is manufactured by processing a silicon single crystal substrate by, for example, semiconductor manufacturing technique, in the same manner as the nozzle plate 111c described above. However, other known methods and materials may be appropriately used for the manufacturing of each of the flow path substrate 111a and the pressure chamber substrate 111b.

The pressure chamber C is a space located between the flow path substrate 111a and the vibration plate 111e. For each of the first row L1 and the second row L2, a plurality of the pressure chambers C are arranged in a direction along the Y axis. Further, the pressure chamber C communicates with each of the communication flow path Na and the supply flow path Ra. Therefore, the pressure chamber C communicates with the nozzle N through the communication flow path Na and communicates with the space R1 through the supply flow path Ra.

The vibration plate 111e is arranged on the surface of the pressure chamber substrate 111b facing the Z1 direction. The vibration plate 111e is a plate-shaped member that can elastically vibrate. The vibration plate 111e has, for example, a first layer and a second layer, which are stacked in the Z1 direction in this order. The first layer is, for example, an elastic film made of silicon oxide (SiO₂). The elastic film is formed, for example, by thermally oxidizing one surface of a silicon single crystal substrate. The second layer is, for example, an insulating film made of zirconium oxide (ZrO₂). The insulating film is formed by, for example, forming a zirconium layer by a sputtering method and thermally oxidizing the layer. The vibration plate 111e is not limited to the above-mentioned stacked configuration of the first layer and the second layer, and may be constituted by, for example, a single layer or three or more layers.

On the surface of the vibration plate 111e facing the Z1 direction, a plurality of drive elements 111f corresponding to the nozzles N are arranged for each of the first row L1 and the second row L2. Each drive element 111f is a passive element that is deformed by the supply of the drive signal. Each drive element 111f has an elongated shape extending in the direction along the X axis in a plan view. The plurality of drive elements 111f are arranged in the direction along the Y axis to correspond to the plurality of pressure chambers C. The drive element 111f overlaps the pressure chamber C in a plan view.

Each drive element 111f is a piezoelectric element, and although not shown, it has a first electrode, a piezoelectric layer, and a second electrode, which are stacked in the Z1 direction in this order. One of the first electrode and the second electrode is an individual electrode arranged apart from other electrodes for each drive element 111f, and a drive pulse PD is supplied to the one electrode. The other electrode of the first electrode and the second electrode is a band-shaped common electrode extending in the direction along the Y axis to be continuous over the plurality of drive elements 111f, and the offset potential VBS is supplied to the other electrode. Examples of the metal material of the electrodes include metal materials such as platinum (Pt), aluminum (Al), nickel (Ni), gold (Au), and copper (Cu), and of the materials, one type can be used alone or two or more types can be used in combination in an alloyed or stacked manner. The piezoelectric layer is made of a piezoelectric material such as lead zirconate titanate (Pb(Zr,Ti)O₃). The piezoelectric layer may be provided individually for each drive element 111f, or may be provided in a band shape extending in the direction along the Y axis to be continuous over the plurality of drive elements 111f. When the vibration plate 111e vibrates in conjunction with the above deformation of the drive elements 111f, the pressures in the pressure chambers C fluctuate, and ink is ejected from the nozzles N.

The protective plates 111g are a plate-shaped members installed on the surface of the vibration plate 111e facing the Z1 direction, and protect the plurality of drive elements 111f and reinforce the mechanical strength of the vibration plate 111e. Here, the plurality of drive elements 111f are accommodated between the protective plates 111g and the vibration plate 111e. The protective plates 111g are made of, for example, a resin material.

The case 111h is a member for storing ink supplied to a plurality of pressure chambers C. The case 111h is made of, for example, a resin material. The case 111h is provided with a space R2 for each of the first row L1 and the second row L2. The space R2 is a space communicating with the above-mentioned space R1 and functions as a reservoir R for storing ink supplied to a plurality of pressure chambers C together with the space R1. The case 111h is provided with an introduction port IH for supplying ink to each reservoir R. The ink in each reservoir R is supplied to the pressure chamber C through each supply flow path Ra.

The vibration absorbing body 111d, also referred to as a compliance substrate, is a flexible resin film constituting a wall surface of the reservoir R, and absorbs pressure fluctuations of ink in the reservoir R. The vibration absorbing body 111d may be a thin plate made of metal and having flexibility. The surface of the vibration absorbing body 111d facing the Z1 direction is joined to the flow path substrate 111a with an adhesive or the like.

The wiring substrate 111i is mounted on the surface of the vibration plate 111e facing the Z1 direction, and is a mounting component for electrically coupling the head chip 111, the drive circuit 112, the control module 110b, and the like. The wiring substrate 111i is a flexible wiring substrate such as a chip on film (COF), a flexible printed circuit (FPC) or a flexible flat cable (FFC). The drive circuit 112 described above is mounted on the wiring substrate 111i of the present embodiment.

### 1-3. Configuration of Processing Apparatus

FIG. 4 is a schematic diagram showing a configuration example of the processing apparatus 200 used in the ink jet system 10 according to the embodiment. As shown in FIG. 4, the processing apparatus 200 includes a display device 210, an input device 220, a communication device 230, a storage circuit 240, and a processing circuit 250. The components are communicatively connected to each other. The display device 210 is an example of a “display portion”.

The display device 210 displays various images under the control of the processing circuit 250. Here, the display device 210 includes a display panel such as a liquid crystal display panel or an organic electro-luminescence (EL) display panel.

The input device 220 is a device that receives operations from the user. For example, the input device 220 includes a pointing device such as a touch pad, a touch panel or a mouse. Here, when the input device 220 includes a touch panel, the input device 220 may also serve as a display device 210. The input device 220 may be provided outside the processing apparatus 200. Further, the input device 220 may include other input devices such as a keyboard.

The communication device 230 is a circuit capable of communicating with each of the printer 100 and the server 300. For example, the communication device 230 is a communication circuit having an interface such as a wireless or wired LAN or USB. The communication device 230 transmits the recorded data DP to the printer 100 by communicating with the printer 100. Further, the communication device 230 transmits the first information D1 and receives the second information D2 by communicating with the server 300. That is, the communication device 230 functions as a connection portion 231 that is communicatively connected to the server 300. The communication device 230 may be integrated with the processing circuit 250.

The storage circuit 240 is a device that stores various programs executed by the processing circuit 250 and various types of data processed by the processing circuit 250. The storage circuit 240 has, for example, a hard disk drive or a semiconductor memory. A part or all of the storage circuit 240 may be provided in a storage device or a server outside the processing apparatus 200.

The storage circuit 240 of the present embodiment stores a program PG1, the first information D1, the second information D2, and the recorded data DP. A part or all of the program PG1, the first information D1, the second information D2 may be stored in a storage device, a server, or the like outside the processing apparatus 200.

The program PG1 is a management program for managing the printer 100, and causes a computer to implement various functions required for the management.

The first information D1 is information regarding the use state of the head 110a. The first information D1 may be any information as long as the information can allow the head manufacturer to determine whether the ejection state from the head 110a is normal or abnormal, and includes, for example, identification information indicating a unique number such as a serial number unique to the head 110a, information regarding the type of liquid used for ejection by the head 110a, information regarding the temperature and humidity of the head 110a, information regarding the waveform of the drive pulse PD, information regarding the number of times of use of the head 110a, such as a dot count, and the like. Examples of the information regarding the type of liquid used for ejection in the head 110a include information regarding a product number, viscosity, residual vibration, ejection speed, and the like, of the ink. Examples of the information regarding the temperature of the head 110a include information regarding the detection temperature of a temperature sensor provided inside or around the head 110a. Examples of the information regarding the humidity of the head 110a include information regarding the detection temperature of a humidity sensor provided inside or around the head 110a. When the head manufacturer owns in advance a part of the information regarding the use state of the head 110a, the part may not be included in the first information D1.

The second information D2 includes information regarding the state of the head 110a. Examples of the information regarding the state of the head 110a include information indicating whether the state of the head 110a is normal or abnormal, information indicating the type, location, or degree of abnormality when the state of the head 110a is abnormal, information regarding a notification from the head manufacturer regarding the abnormality when the state of the head 110a is abnormal, and information such as the use history and the use state of the head 110a.

The processing circuit 250 is a device having a function of controlling each portion of the processing apparatus 200 and a function of processing various types of data. The processing circuit 250 has, for example, a processor such as a central processing unit (CPU). The processing circuit 250 may be constituted by a single processor or may be constituted by a plurality of processors. In addition, some or all of the functions of the processing circuit 250 may be implemented by hardware such as a digital signal processor (DSP), an application specific integrated circuit (ASIC), a programmable logic device (PLD), a field programmable gate array (FPGA).

The processing circuit 250 functions as an acquisition portion 251, an output portion 252, an input portion 253, a display control portion 254, and a reception portion 255 by reading and executing the program PG1 from the storage circuit 240.

The acquisition portion 251 acquires the first information D1. Specifically, when the first information D1 includes identification information indicating a unique number such as a serial number unique to the head 110a, the acquisition portion 251 acquires the identification information by, for example, reading the identification information from the storage circuit 116 of the head 110a. When the first information D1 includes information regarding the type of liquid used for ejection in the head 110a, the acquisition portion 251 acquires the information based on, for example, the result of input by the user to a graphical user interface (GUI) using the display device 210 and the input device 220. When the first information D1 includes information regarding the temperature or humidity of the head 110a, the acquisition portion 251 acquires the information by, for example, acquiring a detection result from a temperature sensor or humidity sensor (not shown) of the printer 100. When the first information D1 includes information regarding the waveform of the drive pulse PD, the acquisition portion 251 acquires the information by, for example, reading the information from the storage circuit 140 of the printer 100. When the first information D1 includes information regarding the number of times of use of the head 110a, the acquisition portion 251 acquires the information by, for example, reading the information from the storage circuit 140 of the printer 100. Note that an acquisition timing of the first information D1 by the acquisition portion 251 may be a regular timing at predetermined time intervals, or may be any timing according to an instruction from the user.

The output portion 252 outputs the first information D1 through the connection portion 231. For example, the output portion 252 outputs the first information D1 to the server 300 through the connection portion 231, by using an instruction or the like issued by a user using the input device 220 as a trigger. The output portion 252 may output other information to the server 300 together with the first information D1.

The second information D2 is input to the input portion 253 through the connection portion 231. For example, the second information D2 is input from the server 300 to the input portion 253 through the connection portion 231, by using an instruction or the like issued by the user using the input device 220 as a trigger.

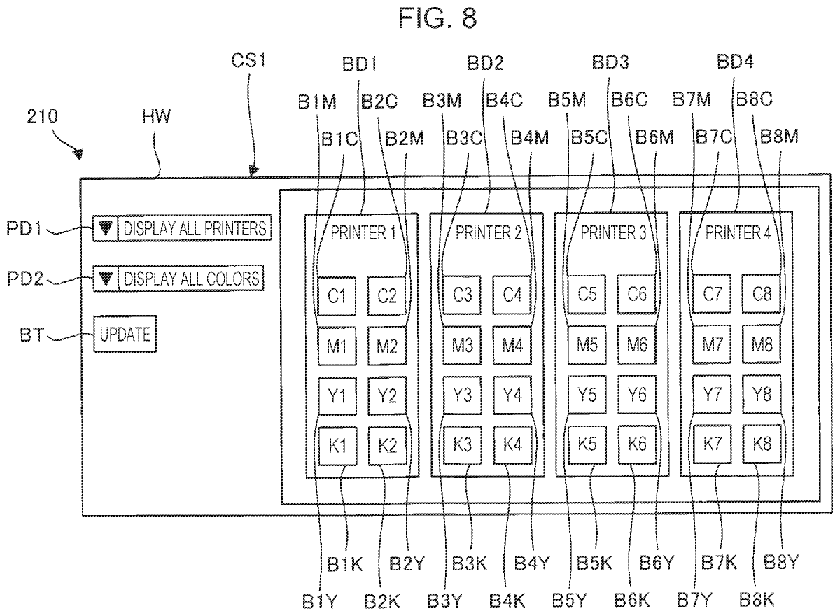

The display control portion 254 performs display on the display device 210 based on the second information D2. Further, the display control portion 254 controls the display on the display device 210 based on the reception result of the reception portion 255. A specific example of this display will be described later with reference to FIGS. 8 to 15.

The reception portion 255 receives an operation from the user on the GUI using the display device 210 and the input device 220.

### 1-4. Configuration of Server

FIG. 5 is a schematic diagram showing a configuration example of the server 300 used in the ink jet system 10 according to the embodiment. As shown in FIG. 5, the server 300 includes a display device 310, an input device 320, a communication device 330, a storage circuit 340, and a processing circuit 350. The components are communicatively connected to each other.

The display device 310 is a device that displays various images under the control of the processing circuit 350, and is configured in the same manner as the display device 210 described above. The input device 320 is a device that receives an operation from the user, and is configured in the same manner as the input device 220 described above. The communication device 330 is a circuit capable of communicating with each processing apparatus 200, and is configured in the same manner as the communication device 230 as described above. The communication device 330 may be integrated with the processing circuit 350.

Here, the communication device 330 receives the first information D1 and transmits the second information D2 by communicating with the processing apparatus 200. That is, the communication device 330 functions as a connection portion 331 that is communicatively connected to the connection portion 231.

The storage circuit 340 is a device that stores various programs executed by the processing circuit 350 and various types of data processed by the processing circuit 350, and is configured in the same manner as the storage circuit 240 described above. A program PG2, the first information D1, and the second information D2 are stored in the storage circuit 340.

The program PG2 is a program that causes a computer to implement various functions necessary for generating the second information D2 according to the first information D1.

The processing circuit 350 is a device having a function of controlling each portion of the server 300 and a function of processing various types of data, and is configured in the same manner as the processing circuit 250 described above. The processing circuit 350 functions as an output portion 351, an input portion 352, and a calculation portion 353 by reading the program PG2 from the storage circuit 340 and executing the program PG2.

The output portion 351 outputs the second information D2 through the connection portion 331. For example, the output portion 351 outputs the second information D2 to the processing apparatus 200 through the connection portion 331, by using an instruction or the like issued by the user using the input device 220 as a trigger.

The first information D1 is input to the input portion 352 through the connection portion 331. For example, the first information D1 is input from the processing apparatus 200 to the input portion 352 through the connection portion 331, by using an instruction or the like by the user using the input device 220 as a trigger.

The calculation portion 353 performs a calculation to generate the second information D2 according to the first information D1. For example, the program PG2 incorporates correspondence information indicating a correspondence relationship between the first information D1 and the state of the head 110a by utilizing the knowledge of the head manufacturer, and the calculation portion 353 uses the correspondence information and the first information D1 to perform calculations to generate the second information D2.

### 1-5. Ink Jet System Processing

As described above, there is a head external sales model, which is a business model in which a head manufacturer sells the head unit 110 or head 110a to a printer manufacturer, and the printer manufacturer manufactures the printer 100. In the head external sales model, the user U who is an end user is either the printer manufacturer itself or the purchaser who purchased the printer from the printer manufacturer.

Here, depending on use, the head 110a may deteriorate or errors such as ejection failure may occur. Since such an error occurs after the head manufacturer sells the head 110a, and the frequency of occurrence and the time it takes to occur are greatly influenced by the use state of the end user, in the related art, the head manufacturer usually cannot recognize the error. Therefore, the inventors devised an ink jet system 10 in which the head manufacturer ascertains the use state of the ink, head, temperature and humidity, dot count, and the like in the head 110a owned by the user U through a cloud network, and notifies the user U of the presence or absence of occurrence of an error according to that use state. In order to implement the ink jet system 10, the head manufacturer provides not only the head 110a but also the program PG1 to the printer manufacturer or the end user. Thereby, the added value is provided rather than providing the head 110a alone to the printer manufacturer or the end user.

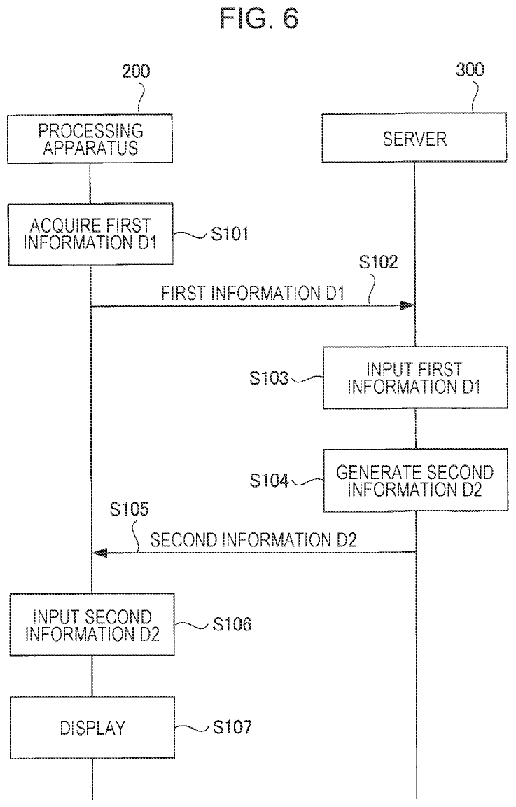

FIG. 6 is a flowchart showing processing between the processing apparatus 200 and the server 300 in the ink jet system 10 according to the embodiment. In the ink jet system 10, first, as shown in FIG. 6, the processing apparatus 200 acquires the first information D1 in step S101. This acquisition is performed by the acquisition portion 251 as described above.

Then, in step S102, the processing apparatus 200 outputs the first information D1 to the server 300.

Specifically, in step S102, the output portion 252 outputs the first information D1 through the connection portion 231 by using the acquisition of the first information D1 as a trigger. A timing at which the first information D1 is output to the connection portion 231 is not limited to the time when the first information D1 is acquired. For example, when the output portion 252 transmits authentication information such as account information and a password for the user to the server 300, and the server 300 succeeds in the authentication using the authentication information, the server 300 may transmit output permission information to the processing apparatus 200, and the output portion 252 may output the first information D1 to the server 300 when the output permission information is received by the processing apparatus 200.

Next, in step S103, the server 300 inputs the first information D1. This input is performed by the input portion 352. Then, in step S104, the server 300 generates the second information D2 based on the first information D1. This generation is performed by the calculation portion 353 as described above. The server 300 may compare the first information D1 with predetermined comparison information, and may cancel the processing after step S104 depending on the comparison result. In this case, the output portion 351 may output information indicating that the second information D2 is not provided.

Then, in step S105, the server 300 outputs the second information D2 to the processing apparatus 200. This output is performed by the output portion 351.

Next, in step S106, the processing apparatus 200 inputs the second information D2. Specifically, in step S106, the second information D2 from the server 300 is input to the input portion 253 through the connection portion 231. The input portion 253 may notify the user of whether or not the second information D2 is input from the server 300 by using the display device 210 or the like, and the second information D2 from the server 300 may be input only when the user inputs an instruction to permit input by the input device 220 or the like.

Then, in step S107, the processing apparatus 200 performs display based on the second information D2. This display is performed by the display control portion 254.

As described above, the ink jet system 10 includes the server 300 that can be connected to the processing apparatus 200. As described above, the server 300 acquires the first information D1 from the processing apparatus 200 and generates the second information D2 based on the first information D1. On the other hand, the processing apparatus 200 acquires the second information D2 from the server, and causes the display device 210 to display state information B1C to B8K, which will be described later, based on the second information D2.

In this manner, by using the server 300, it is possible to obtain the state information B1C to B8K by utilizing the knowledge of the administrator or the user of the server 300. Here, the administrator or the user of the server 300 is the manufacturer of the head unit 110 or the head 110a as described above. Therefore, by utilizing the knowledge of the administrator or the user of the server 300, it is possible to accurately determine the state of the head unit 110 or the head 110a, and then obtain the appropriate state information B1C to B8K.

Here, the ink jet system 10 causes the processing apparatus 200 such as a PC or a smartphone owned by the end user to display the state information, which is the information indicating which head 110a is causing an error. In the previous studies, the inventors assumed one printer 100 on which a plurality of heads 110a are mounted, and did not assume a display based on a plurality of printers 100. Therefore, the inventors have found a method of displaying the state information that makes it easier to see when a plurality of printers 100 are assumed. The display will be described in detail below.

### 1-6. Display on Display Portion

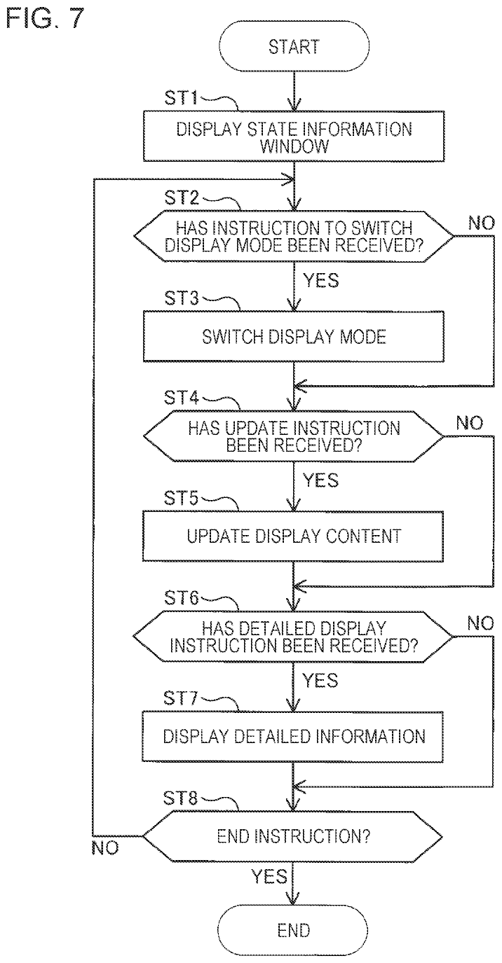

FIG. 7 is a flowchart showing display processing in the processing apparatus 200. In step S107 described above, first, in step ST1, the display control portion 254 causes the display device 210 to display information indicating the state of each head 110a based on the second information D2. This information is included in a state display window HW, which will be described later.

After step ST1, in step ST2, the display control portion 254 determines whether or not an instruction to switch the display mode of the state display window HW has been received. This determination is made based on the presence or absence of an operation on pull-down menus PD1 and PD2, which will be described later.

When the instruction to switch the display mode of the state display window HW has been received (step ST2: YES), in step ST3, the display control portion 254 switches the display mode of the state display window HW. This switching is performed according to operation content of the pull-down menus PD1 and PD2, which will be described later.

When the instruction to switch the display mode of the state display window HW has not been received (step ST2: NO), or after step ST3, in step ST4, the display control portion 254 determines whether or not an instruction to update the display of the state display window HW has been received. This determination is made based on the presence or absence of an operation on an update button BT, which will be described later.

When the instruction to update the display of the state display window HW has been received (step ST4: YES), in step ST5, the display control portion 254 updates the display of the state display window HW. This update is performed by re-executing steps S101 to S107 shown in FIG. 6 described above, and then displaying the state display window HW based on the new second information D2.

When the instruction to update the display of the state display window HW has not been received (step ST4: NO), or after step ST5, in step ST6, the display control portion 254 determines whether or not an instruction to display detailed state information DW, which will be described later, including information indicating the state of the head 110a in detail, has been received. This determination is made based on the presence or absence of an operation on any of state information BIM to B8K, which will be described later.

When the instruction to display the detailed state information DW has been received (step ST6: YES), in step ST7, the display control portion 254 causes the display device 210 to display the detailed state information DW. This display is performed according to the type of state information operated among the state information BIM to B8K, which will be described later.

When the instruction to display the detailed state information DW has not been received (step ST6: NO), or after step ST7, in step ST8, the display control portion 254 determines whether or not an end instruction has been received. The determination is made, for example, based on whether or not an operation for closing the state display window HW has been performed.

When there is no end instruction (step ST8: NO), the display control portion 254 returns to step ST2 described above. On the other hand, when there is an end instruction (step ST8: YES), the display control portion 254 ends the display processing by ending the display of the state display window HW.

FIG. 8 is a diagram showing an example of a first display mode CS1. In step ST1 described above, the state display window HW is displayed on the display device 210, as shown in FIG. 8. FIG. 8 shows the state display window HW of the first display mode CS1. In FIG. 8, a case is illustrated in which each printer 100 includes two head units 110, and each head unit 110 includes four liquid ejecting heads 110a: one liquid ejecting head 110a for cyan ink, one liquid ejecting head 110a for magenta ink, one liquid ejecting head 110a for yellow ink, and one liquid ejecting head 110a for black ink.

Here, cyan is an example of a “first color”, and magenta is an example of a “second color different from the first color”.

The liquid ejecting head 110a for cyan ink provided in the head unit 110-1 of the printer 100-1 is an example of a “first head”.

The liquid ejecting head 110a for magenta ink provided in the head unit 110-1 of the printer 100-1 is an example of a “second head”.

The liquid ejecting head 110a for cyan ink provided in the head unit 110-3 of the printer 100-2 is an example of a “third head”.

The liquid ejecting head 110a for magenta ink provided in the head unit 110-3 of the printer 100-2 is an example of a “fourth head”.

That is, the “first head” and the “second head” correspond to the same printer 100-1 and correspond to ink of different colors. Further, the “third head” and the “fourth head” correspond to the same printer 100-3 and correspond to ink of different colors. Furthermore, the “first head” and the “third head” correspond to different printers and correspond to ink of the same color (cyan). Moreover, the “second head” and the “fourth head” correspond to different printers and correspond to ink of the same color (magenta).

The state display window HW includes state information B1C, B2C, B1M, B2M, B1Y, B2Y, B1K, B2K, B3C, B4C, B3M, B4M, B3Y, B4Y, B3K, B4K, B5C, B6C, B5M, B6M, B5Y, B6Y, B5K, B6K, B7C, B8C, B7M, B8M, B7Y, B8Y, B7K, and B8K, boundary information BD1, BD2, BD3, and BD4, pull-down menus PD1 and PD2, and an update button BT.

Hereinafter, the state information B1C, B2C, B1M, B2M, B1Y, B2Y, B1K, B2K, B3C, B4C, B3M, B4M, B3Y, B4Y, B3K, B4K, B5C, B6C, B5M, B6M, B5Y, B6Y, B5K, B6K, B7C, B8C, B7M, B8M, B7Y, B8Y, B7K, and B8K may be collectively referred to as state information B1C to B8K.

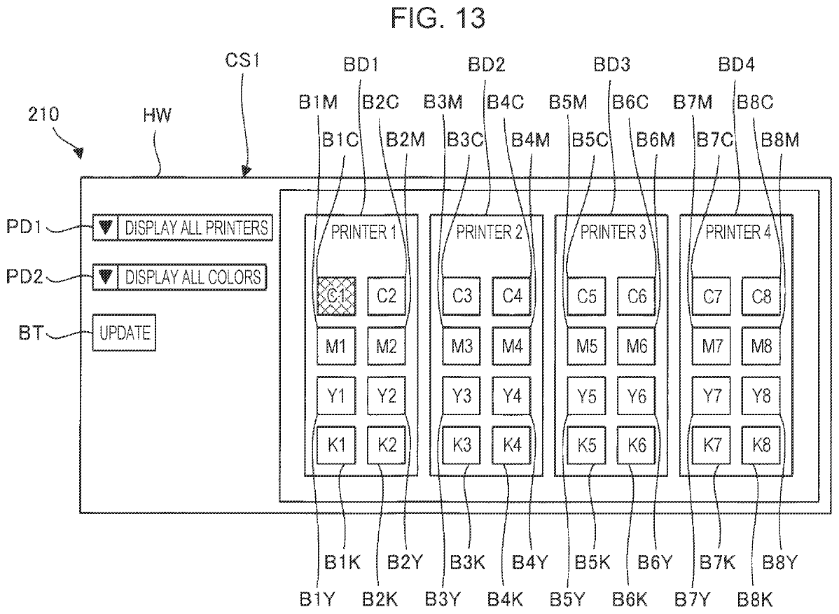

Each piece of the state information B1C to B8K is information indicating the state of the corresponding liquid ejecting head 110a. For example, each piece of the state information B1C to B8K is displayed in a mode such as different colors, brightness, presence or absence of blinking, and the like depending on whether or not the ejection state from the corresponding liquid ejecting head 110a is normal. Further, when the ejection state from the head 110a is abnormal, each piece of the state information B1C to B8K is displayed in a mode such as different colors, brightness, presence or absence of blinking, and the like depending on the degree of the abnormality. This point will be described later with reference to FIG. 13.

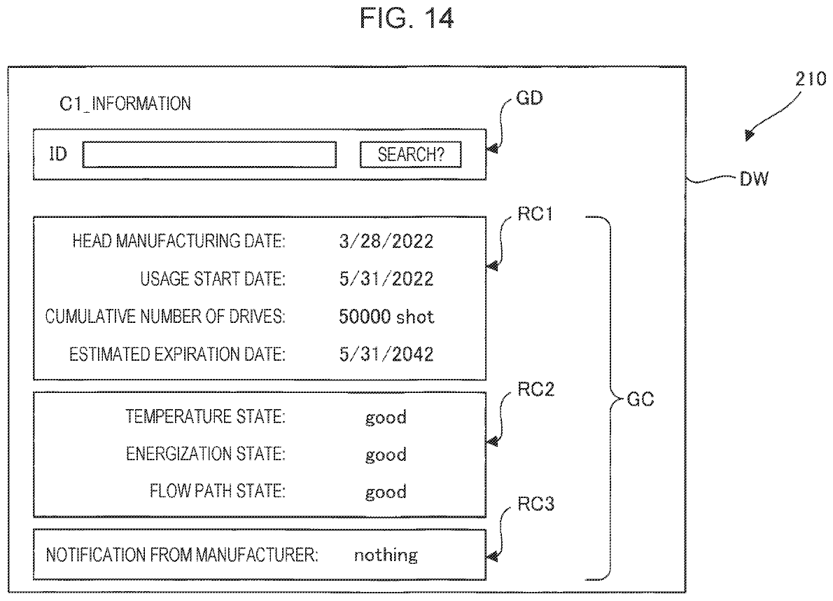

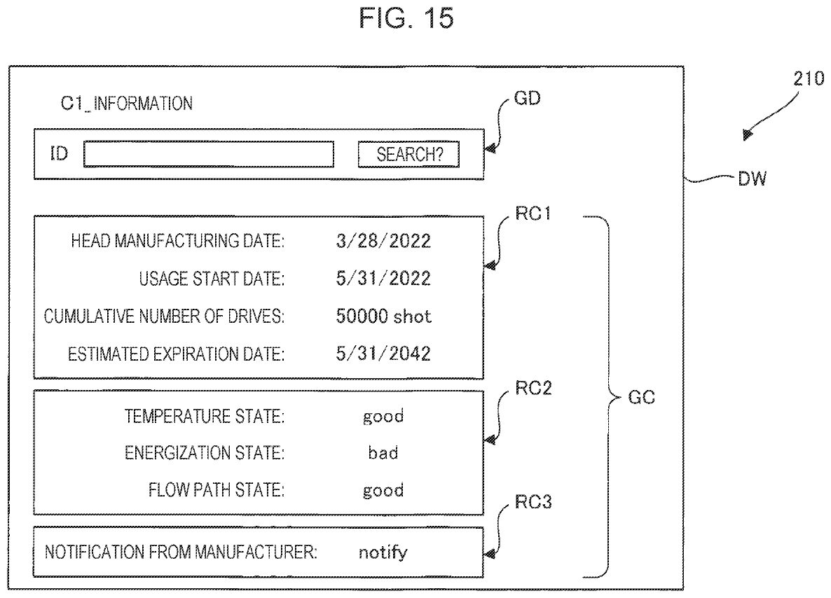

In addition, each piece of the state information B1C to B8K can receive an operation by the user U, and when the operation by the user U is received, detailed state information DW, which will be described later, is displayed in a separate window. This point will be described later with reference to FIGS. 14 and 15.

Next, what each piece of the state information indicates will be described in detail.

The state information B1C, B2C, B3C, B4C, B5C, B6C, B7C, and B8C correspond to the liquid ejecting head 110a for cyan ink.

The state information BIM, B2M, B3M, B4M, B5M, B6M, B7M, and B8M correspond to the liquid ejecting head 110a for magenta ink.

The state information B1Y, B2Y, B3Y, B4Y, B5Y, B6Y, B7Y, and B8Y correspond to the liquid ejecting head 110a for yellow ink.

The state information B1K, B2K, B3K, B4K, B5K, B6K, B7K, and B8K correspond to the liquid ejecting head 110a for black ink.

One row of state information arranged in the vertical direction corresponds to the liquid ejecting head belonging to the same head unit.

The state information B1C, BIM, B1Y, and B1K correspond to the liquid ejecting head 110a of the head unit 110-1.

The state information B2C, B2M, B2Y, and B2K correspond to the liquid ejecting head 110a of the head unit 110-2.

The state information B3C, B3M, B3Y, and B3K correspond to the liquid ejecting head 110a of the head unit 110-3.

The state information B4C, B4M, B4Y, and B4K correspond to the liquid ejecting head 110a of the head unit 110-4.

The state information B5C, B5M, B5Y, and B5K correspond to the liquid ejecting head 110a of the head unit 110-5.

The state information B6C, B6M, B6Y, and B6K correspond to the liquid ejecting head 110a of the head unit 110-6.

The state information B7C, B7M, B7Y, and B7K correspond to the liquid ejecting head 110a of the head unit 110-7.

The state information B8C, B8M, B8Y, and B8K correspond to the liquid ejecting head 110a of the head unit 110-8.

The printer 100-1 is provided with the head unit 110-1 and the head unit 110-2. Therefore, the state information B1C, B1M, B1Y, B1K, B2C, B2M, B2Y, and B2K correspond to the printer 100-1.

The printer 100-2 is provided with the head unit 110-3 and the head unit 110-4. Therefore, the state information B3C, B3M, B3Y, B3K, B4C, B4M, B4Y, and B4K correspond to the printer 100-2.

The printer 100-3 is provided with the head unit 110-5 and the head unit 110-6. Therefore, the state information B5C, B5M, B5Y, B5K, B6C, B6M, B6Y, and B6K correspond to the printer 100-3.

The printer 100-4 is provided with the head unit 110-7 and the head unit 110-8. Therefore, the state information B7C, B7M, B7Y, B7K, B8C, B8M, B8Y, and B8K correspond to the printer 100-4.

As can be seen from the above, for example, the state information B1C corresponds to the liquid ejecting head 110a for cyan ink arranged in the head unit 110-1 of the printer 100-1, that is, the “first head”. The state information B1C is an example of “first state information”.

Further, for example, the state information B1M corresponds to the liquid ejecting head 110a for magenta ink arranged in the head unit 110-1 of the printer 100-1, that is, the “second head”. The state information B1M is an example of “second state information”.

Further, for example, the state information B3C corresponds to the liquid ejecting head 110a for cyan ink arranged in the head unit 110-3 of the printer 100-2, that is, the “third head”. The state information B3C is an example of “third state information”.

Further, for example, the state information B3M corresponds to the liquid ejecting head 110a for magenta ink arranged in the head unit 110-3 of the printer 100-2, that is, the “fourth head”. The state information B3M is an example of “fourth state information”.

In this way, in the present embodiment, the state information is summarized for each printer.

In other words, when the region in which each piece of state information is displayed is divided into four regions in the left-right direction, the state information B1C, B1M, B1Y, B1K, B2C, B2M, B2Y, and B2K corresponding to the printer 100-1 are collected in the leftmost region.

Further, in the region second from the left, the state information B3C, B3M, B3Y, B3K, B4C, B4M, B4Y, and B4K corresponding to the printer 100-2 are collected.

Further, in the second region from the right, the state information B5C, B5M, B5Y, B5K, B6C, B6M, B6Y, and B6K corresponding to the printer 100-3 are collected.

Further, in the rightmost region, the state information B7C, B7M, B7Y, B7K, B8C, B8M, B8Y, and B8K corresponding to the printer 100-4 are collected.

Therefore, when the state of the liquid ejecting head 110a becomes abnormal, it is easy to understand which printer the liquid ejecting head 110a is arranged in.

Also, since the state information is summarized for each printer 100, the information on the liquid ejecting head 110a belonging to each printer 100 can be visually recognized together.

Here, although not essential, as shown in FIG. 8, it is preferable that the distance between the pieces of state information corresponding to different printers is longer than the distance between the pieces of state information corresponding to the same printer. The distance mentioned here is a distance between the closest pieces of state information. For example, the state information B2C corresponding to the printer 100-1 and the state information B3C corresponding to the printer 100-2 are in the closest relationship among different printers. In addition, the state information B1C and B2C corresponding to the printer 100-1 are in the closest relationship among the same printers. Therefore, the distance between the state information B2C and B3C is compared with the distance between the state information B1C and B2C. In this case, the former is longer than the latter. Thereby, it is possible to make it easier to understand which printer certain state information belongs to.

In addition, although not essential, as shown in FIG. 8, it is preferable that the boundary information BD1, BD2, BD3, and BD4 are displayed between the pieces of state information corresponding to different printers. In the example shown in FIG. 8, the boundary information BD1 is information indicating a frame surrounding state information corresponding to the printer 100-1, and the characters “Printer 1” indicating that it belongs to the printer 100-1 are displayed within the frame. With such boundary information BD1, among the state information B1C to B8K, the state information B1C to B2K of the head 110a belonging to the printer 100-1 can be visually distinguished from the others.

The boundary information BD2 is information indicating a frame surrounding state information corresponding to the printer 100-2, and the characters “Printer 2” indicating that it belongs to the printer 100-2 are displayed within the frame.

The boundary information BD3 is information indicating a frame surrounding the state information B5C to B6K of the head 110a corresponding to the printer 100-3, and the characters “Printer 3” indicating that it belongs to the printer 100-3 are displayed within the frame.

The boundary information BD4 is information indicating a frame surrounding the state information B7C to B8K of the head 110a corresponding to the printer 100-4, and the characters “Printer 4” indicating that it belongs to the printer 100-4 are displayed within the frame.

Such boundary information BD1, BD2, BD3, and BD4 makes it easier to visually distinguish which of the printers 100-1, 100-2, 100-3, and 100-4 belong.

As described above, the processing apparatus 200 causes the display device 210 to display the state information B1C to B8K indicating the state of the heads 110a of the printers 100-1 to 100-4. Therefore, the user U can be notified of the state of each head 110a of the printers 100-1 to 100-4 at the same time. That is, the user U can be notified of the state of each head 110a for each of the printers 100-1 to 100-4 at the same time. Therefore, it is possible to provide the state of the heads 110a of the plurality of printers 100 in an easy-to-view manner.

As described above, the processing apparatus 200 causes the display device 210 to display the state information B1C to B8K in a distinguishable manner for each printer 100 on one screen. Therefore, in a state in which of the printers 100-1 to 100-4 the head 110a belongs to is distinguished, the states of all the heads 110a of the printers 100-1 to 100-4 can be visually notified to the user at once and at the same time. For example, for the printers 100-1 and 100-2, the processing apparatus 200 displays the state information B1C (first state information), the state information B1M (second state information), the state information B3C (third state information) and the state information B3M (fourth state information) in a distinguishable manner on one screen. Therefore, in a state in which of the printer 100-1 and the printer 100-2 the head belongs to is distinguished, the state of each of the first head 110a and the second head 110a and the third head 110a and the fourth head 110a can be visually notified to the user U at once and at the same time.

The above has described what the state information indicates in the present embodiment.

Next, elements other than the state information included in the state display window HW of the present embodiment will be described.

Each of the pull-down menus PD1 and PD2 is a widget for switching the display mode of the state information B1C to B8K.

Specifically, the pull-down menu PD1 is a widget for designating the printer 100 to be displayed among the state information B1C to B8K. FIG. 8 shows the pull-down menu PD1 in a state in which the printers 100-1 to 100-4 are designated, and in the pull-down menu PD1, the characters “Display all printers” indicating that the printers 100-1 to 100-4 are designated are displayed. In the pull-down menu PD1, in addition to designating the printers 100-1 to 100-4, it is possible to designate one or more of the printers 100-1 to 100-4 in any manner.

The pull-down menu PD2 is a widget for designating the ink color to be displayed among the state information B1C to B8K. FIG. 8 shows the pull-down menu PD2 in a state in which all the ink colors are designated, and in the pull-down menu PD2, the characters “Display all colors” indicating that all the ink colors are designated are displayed. In the pull-down menu PD2, in addition to designating all ink colors, it is possible to designate one or more of cyan, magenta, yellow, and black in any manner.

In this way, by designating the printers 100-1 to 100-4 as the display targets and designating all the ink colors, the state information B1C to B8K are displayed in the first display mode CS1 so as to be emphasized to the same extent. Therefore, the first display mode CS1 is preferable when the information on the state of all the heads 110a of the printers 100 is required.

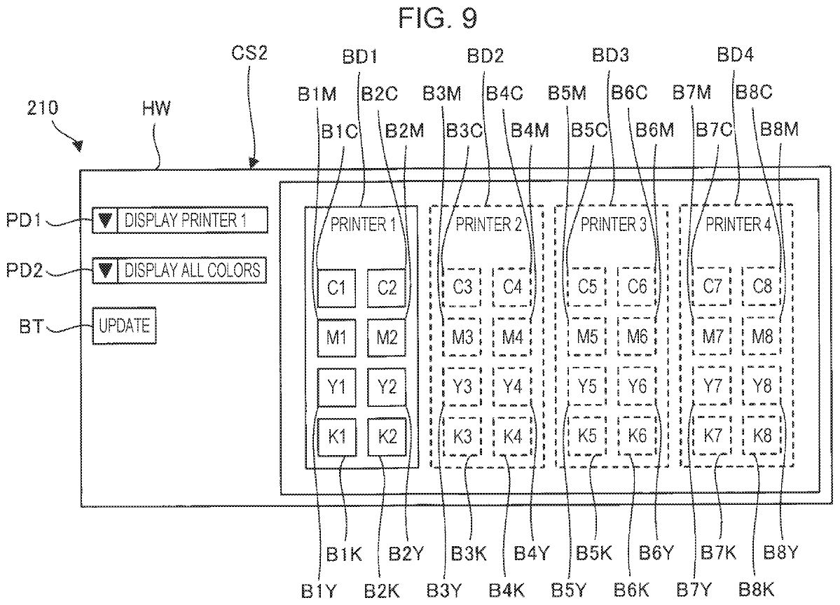

Examples of the display mode to “emphasize an object” include a mode in which an object to be emphasized is displayed brighter than other objects, a mode in which an object to be emphasized is displayed while other objects are hidden, a mode in which an object to be emphasized is displayed and other objects are grayed out, and the like. In addition, in FIG. 9, for convenience of drawing, objects to be emphasized are indicated by solid lines, and other objects are indicated by broken lines.

For example, in the first display mode CS1, the state information B1C (first state information), the state information B1M (second state information), the state information B3C (third state information), and the state information B3M (fourth state information) are displayed so as to be emphasized to the same extent as each other. Therefore, the first display mode CS1 is preferable when the information on the states of both the head 110a belonging to the printer 100-1 and the head 110a belonging to the printer 100-2 is required. In addition, it is preferable when information on both the cyan and magenta heads 110a is required for each of the printer 100-1 and the printer 100-2.

The update button BT is a widget for updating the contents of the state information B1C to B8K to the latest state. By operating the update button BT, step ST5 shown in FIG. 7 described above is executed.

FIG. 9 is a diagram showing an example of a second display mode CS2. FIG. 9 shows a state display window HW of the second display mode CS2. FIG. 9 shows the pull-down menu PD1 in a state in which the printer 100-1 is designated, and in the pull-down menu PD1, the characters “Display printer 1” indicating that the printer 100-1 is designated are displayed.

In this way, by designating the printer 100-1 as the display target, the state information B1C to B2K indicating the state of the head 110a belonging to the printer 100-1 among the state information B1C to B8K are displayed in the second display mode CS2 so as to be emphasized compared to the others. Therefore, the second display mode CS2 is preferable when the information on the state of the head 110a of the printer 100-1 is required.

For example, in the second display mode CS2, the state information B1C (first state information) and the state information B1M (second state information) are displayed so as to be emphasized compared to the state information B3C (third state information) and the state information B3M (fourth state information). Therefore, the second display mode CS2 is preferable when the information on the state of the head 110a belonging to the printer 100-2 is not required, but the information on the state of the head 110a belonging to the printer 100-1 is required.

As described above, the processing apparatus 200 can switch between the first display mode CS1 and the second display mode CS2. Therefore, information necessary for the user U can be changed by switching between the first display mode CS1 and the second display mode CS2.

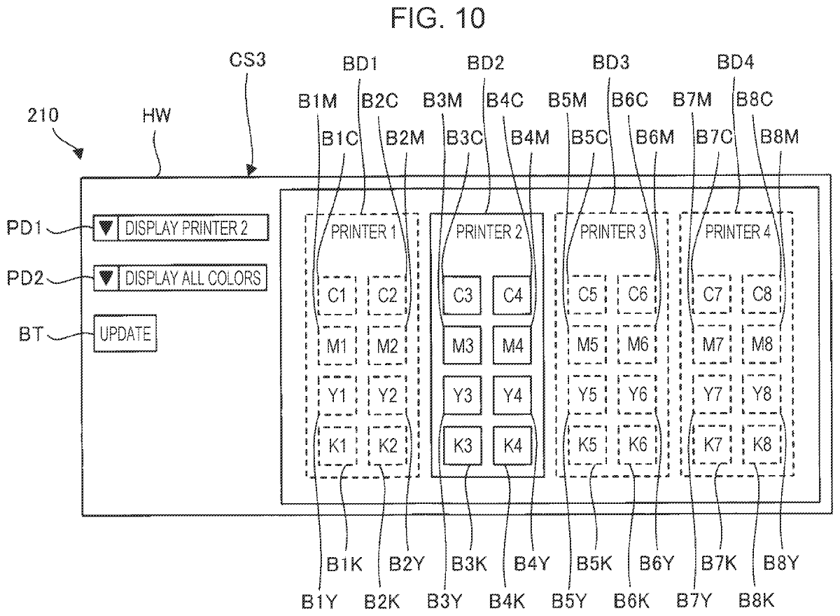

FIG. 10 is a diagram showing an example of a third display mode CS3. FIG. 10 shows a state display window HW of the third display mode CS3. FIG. 10 shows the pull-down menu PD1 in a state in which the printer 100-2 is designated, and in the pull-down menu PD2, the characters “Display printer 2” indicating that the printer 100-2 is designated are displayed.

In this way, by designating the printer 100-2 as the display target, the state information B3C to B4K indicating the state of the head 110a belonging to the printer 100-2 among the state information B1C to B8K are displayed in the third display mode CS3 so as to be emphasized compared to the others. Therefore, the third display mode CS3 is preferable when the information on the state of the head 110a of the printer 100-2 is required.

For example, in the third display mode CS3, the state information B3C (third state information) and the state information B3M (fourth state information) are displayed so as to be emphasized compared to the state information B1C (first state information) and the state information B1M (second state information). Therefore, the third display mode CS3 is preferable when the information on the state of the head 110a belonging to the printer 100-1 is not required, but the information on the state of the head 110a belonging to the printer 100-2 is required.

As described above, the processing apparatus 200 can further switch the third display mode CS3. That is, the processing apparatus 200 can switch between the first display mode CS1, the second display mode CS2, and the third display mode CS3. Therefore, information necessary for the user can be changed by switching between the first display mode CS1, the second display mode CS2, and the third display mode CS3.

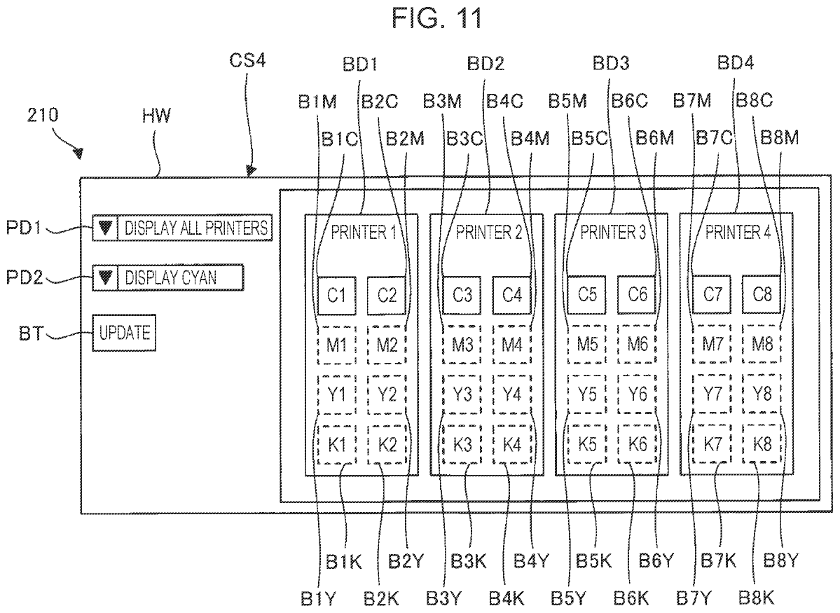

FIG. 11 is a diagram showing an example of a fourth display mode CS4. FIG. 11 shows a state display window HW of the fourth display mode CS4. FIG. 11 shows the pull-down menu PD2 in a state in which the cyan color is designated, and in the pull-down menu PD2, the characters “Display cyan” indicating that the cyan color is designated are displayed.

In this way, by designating the cyan color as the display target, the state information B1C, B2C, B3C, B4C, B5C, B6C, B7C, and B8C indicating the state of the head 110a for cyan ink among the state information B1C to B8K are displayed in the fourth display mode CS4 so as to be emphasized compared to the others. Therefore, the fourth display mode CS4 is preferable when the information on the state of the head 110a for cyan ink is required.

For example, in the fourth display mode CS4, the state information B1C (first state information) and the state information B3C (third state information) are displayed so as to be emphasized compared to the state information B1M (second state information) and the state information B3M (fourth state information). Therefore, the fourth display mode CS4 is preferable when, for each of the printer 100-1 and the printer 100-2, the information on the state of the head 110a using second ink is not required, but the information on the state of the head 110a using first ink is required.

As described above, the processing apparatus 200 can switch between the first display mode CS1 and the fourth display mode CS4. Therefore, by switching between the first display mode CS1 and the fourth display mode CS4, regardless of which printer 100 the head 110a belongs to, information necessary for the user U can be changed depending on the color of the ink used in the head 110a.

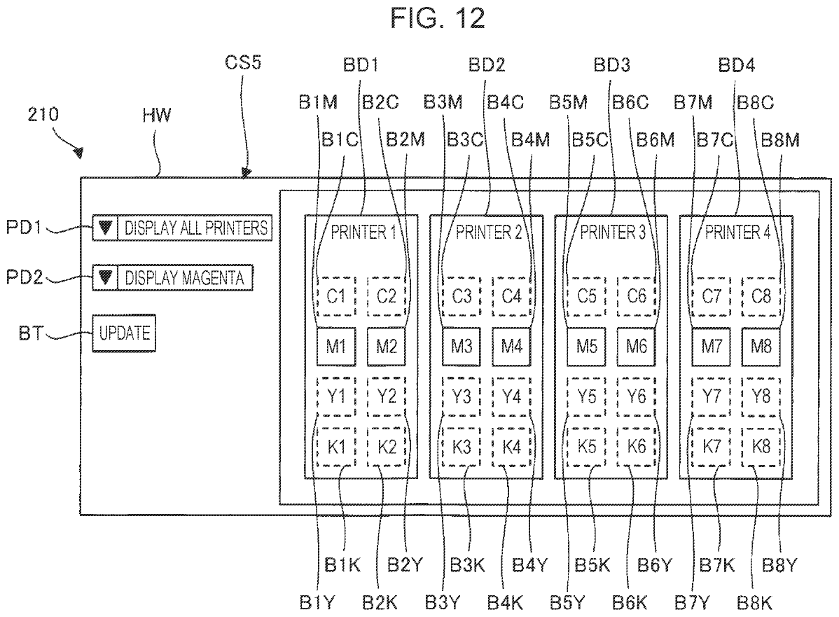

FIG. 12 is a diagram showing an example of a fifth display mode CS5. FIG. 12 shows a state display window HW of the fifth display mode CS5. FIG. 12 shows the pull-down menu PD2 in a state in which the magenta color is designated, and in the pull-down menu PD2, the characters “Display magenta” indicating that the magenta color is designated are displayed.

In this way, by designating the magenta color as the display target, the state information B1M, B2M, B3M, B4M, B5M, B6M, B7M, and B8M indicating the state of the head 110a for magenta ink among the state information B1C to B8K are displayed in the fifth display mode CS5 so as to be emphasized compared to the others. Therefore, the fifth display mode CS5 is preferable when the information on the state of the head 110a for magenta ink is required.

For example, in the fifth display mode CS5, the state information B1M (second state information) and the state information B3M (fourth state information) are displayed so as to be emphasized compared to the state information B1C (first state information) and the state information B3C (third state information). Therefore, the fifth display mode CS5 is preferable when, for each of the printer 100-1 and the printer 100-2, the information on the state of the head 110a using first ink is not required, but the information on the state of the head 110a using second ink is required.

As described above, the processing apparatus 200 can further switch the fifth display mode CS5. That is, the processing apparatus 200 can switch between the first display mode CS1, the fourth display mode CS4, and the fifth display mode CS5. Therefore, by switching between the first display mode CS1, the fourth display mode CS4, and the fifth display mode CS5, for example, regardless of which printer 100 the head 110a belongs to, information necessary for the user U can be changed depending on the color of the ink used in the head 110a.

FIG. 13 is a diagram showing a display example when the ejection state from the liquid ejecting head 110a (first head) for cyan ink arranged in the head unit 110-1 of the printer 100-1 is abnormal. In FIG. 13, a state in which the state information B1C indicating the state of the head 110a displays an abnormality is shown in the state display window HW of the first display mode CS1. Note that in FIG. 13, the state information B1C is displayed in a shaded manner for convenience of drawing. The state information corresponding to the other heads 110a shows a state displaying a normality. In FIG. 13, the state information B1C is displayed without shading for convenience of drawing.

In this way, the processing apparatus 200 displays the state information in a different manner depending on whether the ejection state from the head 110a is normal or abnormal. Therefore, it is possible to notify the user whether or not the ejection state from the head 110a is normal, in other words, whether or not the ejection state from the head 110a is abnormal. By displaying the information on the other heads 110a in the same manner, it is possible to notify the user whether the information on the other heads 110a is normal or abnormal.

Here, “making the display different” means that, for example, the color, brightness, presence or absence of blinking, time interval of blinking, and the like of the display are different. More specifically, in order for the user U to be able to recognize the presence of the abnormality, when green displays a normality, red displays a failure, and when constant lighting displays a normality, blinking displays an abnormality, etc.

Furthermore, the processing apparatus 200 displays the state information differently in a stepwise manner depending on the degree of the abnormality of the ejection state from the head 110a. Therefore, it is possible to notify the user of the degree of abnormality in the ejection state from the head 110a in a stepwise manner. Such a stepwise display is useful from a usability perspective because, for example, the user U can take countermeasures in advance as needed or reduce the occurrence of periods during which the user U cannot use the printer 100. For example, when there is a nozzle N with ejection failure, in a case in which it is possible to maintain a predetermined image quality by interpolation processing using other nozzles because the number of nozzles with ejection failure is small, a display is made indicating that the degree of abnormality or urgency is low. In contrast, in a case in which it is impossible to maintain a predetermined image quality by interpolation processing using the other nozzles because the number of nozzles with ejection failure is large, a display is made indicating that the degree of abnormality or urgency is high.

Here, “making the display different in a stepwise manner” means, for example, changing the color, brightness, presence or absence of blinking, time interval of blinking, and the like of the display as the degree or the urgency of the abnormality increases. More specifically, in order for the user U to be able to recognize the degree of abnormality, for example, when green displays a normality, the display changes from yellow to red as the degree of abnormality increases, and when constant lighting displays a normality, the time interval of blinking is shortened as the degree of abnormality increases, etc.

FIG. 14 is a diagram showing a display example of the detailed state information DW of the head 110a in a normal ejection state. FIG. 14 illustrates the detailed state information DW displayed when the operation of the user U is performed on the above-mentioned state information B1C in a case in which the head 110a is in a normal ejection state. The detailed state information DW is an example of “first detailed state information”.

For example, when an operation of the user U such as clicking is performed on the state information B1C (first state information), as shown in FIG. 14, the detailed state information DW indicating detailed information regarding the first head 110a is displayed on the display device 210 in a window separate from the state display window HW described above.

In the example shown in FIG. 14, detailed state information DW includes property information GC and an input field GD.

The input field GD is a GUI image for inputting identification information such as a serial number or other unique number unique to the head 110a. In the example shown in FIG. 14, the input field GD has a button and a text box. The identification information is input to the text box. The button is operated after the identification information is input to the text box. In this way, the processing apparatus 200 requests various types of information related to the identification information from the server 300. Then, the server 300 transmits various types of information to the processing apparatus 200. The processing apparatus 200 acquiring the various types of information displays the various types of information as the property information GC. The property information GC includes regions RC1, RC2, and RC3.

Information regarding an expiration date of the head 110a is displayed in the region RC1. In the example shown in FIG. 14, items such as a manufacturing date of the target head 110a, a usage start date, a cumulative number of drives, and an estimated expiration date are displayed in the region RC1. The expiration date is determined by the server 300, for example, based on one or both of the number of days elapsed from the usage start date and the cumulative number of drives and the identification information. Here, when a certain period of time elapses from the head manufacturing date, the server 300 may determine that the expiration date is reached regardless of the number of days elapsed from the usage start date and the cumulative number of drives. The item displayed in the region RC1 is not limited to the example shown in FIG. 14, as long as the user can be notified of the expiration date of the head 110a.

The region RC2 indicates the quality of the temperature state, energization state, and flow path state of the target head 110a. In the example shown in FIG. 14, since the target head 110a is normal, “good” indicating that all of the states are good is displayed.

In the region RC3, a notification from the head manufacturer is displayed based on the second information D2. For example, when the target head 110a is defective, a message to that effect is displayed in the region RC3. In the example shown in FIG. 14, “nothing” is displayed because the target head 110a is normal.

FIG. 15 is a diagram showing a display example of the detailed state information DW of the head 110a in an abnormal ejection state. FIG. 15 illustrates the detailed state information DW displayed when the operation of the user U is performed on the above-mentioned state information B1C in a case in which the head 110a is in an abnormal ejection state.

In the example shown in FIG. 15, in the region RC2, “bad” indicating that the energization state is abnormal among the temperature state, energization state, and flow path state is displayed, and “good” indicating that the other states are normal is displayed. In addition, in the region RC3, “notify” indicating that the use of the target head 110a is not recommended is displayed. In this case, necessary information may be provided to the user later by the head manufacturer or the printer manufacturer in an appropriate method.

As described above, the processing apparatus 200 receives designation of the head 110a by the user U, and displays first detailed state information indicating the state of the head 110a in more detail than the state information based on the designation. Therefore, the user U can ascertain detailed information regarding the head 110a as needed. Although the detailed information of the first head 110a is described above, detailed information regarding the heads 110a other than the first head 110a can be similarly known.

### 2. Modification Example

Although the ink jet system of the present disclosure has been described above based on the illustrated embodiment, the present disclosure is not limited thereto. Further, the configuration of each portion of the present disclosure can be replaced with any configuration that exhibits the same functions as that of the above-described embodiment, or any configuration can be added.

### 2-1. Modification Example 1

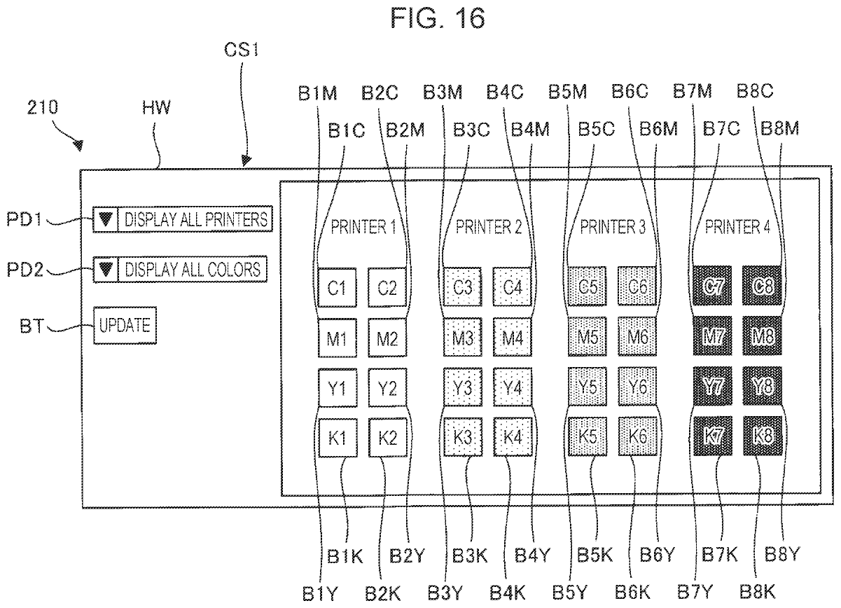

FIG. 16 is a diagram showing an example of the first display mode CS1 in Modification Example 1. FIG. 16 shows a state display window HW of the first display mode CS1. The state display window HW of Modification Example 1 is similar to the state display window HW of the above-described embodiments except that the boundary information BD1, BD2, BD3, and BD4 are omitted and the colors of the state information B1C to B8K are different.

Here, the state information B1C to B8K have different colors for each printer 100. In FIG. 16, for convenience of drawing, the state information B1C to B8K are displayed in a gray scale with a different density for each printer 100. Thereby, the state information B1C to B8K can be displayed in a distinguishable manner for each printer 100.

For example, the processing apparatus 200 of Modification Example 1 causes the display device 210 to display the state information B1C and the state information B1M and the state information B3C and the state information B3M, with a difference in a color. Therefore, by the colors displayed on the display device 210, it is possible to visually and easily distinguish the state information B1C and the state information B1M regarding the printer 100-1 from the state information B3C and the state information B3M regarding the printer 100-2. Note that the state information B1C to B8K can be displayed in a distinguishable manner for each printer 100 by using different fonts or sizes without being limited to the aspect of different colors.

### 2-2. Modification Example 2

In the above-described embodiment, an aspect in which the state information is individually displayed for each liquid ejecting head 110a has been exemplified, but the present disclosure is not limited to this aspect, and a plurality of liquid ejecting heads 110a belonging to the same head unit 110 may be grouped together, and state information for each head unit 110 may be displayed together. Further, the display mode of the state information described above is an example, the present disclosure is not limited thereto, and for example, forms such as a shape and a size arrangement may be appropriately changed.

### 2-3. Modification Example 3

In the above-described embodiment, the configuration in which the server 300 is a cloud server is exemplified, but the configuration is not limited thereto. For example, the server 300 may be a server other than a cloud server or a virtual server, or may be an on-premises server.

### 2-4. Modification Example 4

In the above-described embodiment, the configuration in which the drive element 111f is a piezoelectric element is exemplified, but the configuration is not limited thereto, and for example, the drive element 111f may be a heater that heats ink in the pressure chamber C. That is, the drive method of the head chip 111 is not limited to the piezoelectric method, and may be, for example, a thermal method.

### 3. Additional Notes

A summary of the present disclosure is added below.

(Additional Note 1) An ink jet system according to a first aspect that is a preferred example of the present disclosure is an ink jet system including: a first recording apparatus in which at least a first head and a second head are mounted; a second recording apparatus in which at least a third head and a fourth head are mounted; and a processing apparatus that is commonly coupled to the first recording apparatus and the second recording apparatus and includes a display portion, in which the processing apparatus causes the display portion to display first state information indicating a state of the first head, second state information indicating a state of the second head, third state information indicating a state of the third head, and fourth state information indicating a state of the fourth head.

In the above first aspect, since the first state information, the second state information, the third state information, and the fourth state information are displayed on the display portion, the user can be notified of the state of each of the first head, the second head, the third head, and the fourth head at the same time. That is, the user can be notified of the state of each head for each of the first recording apparatus and the second recording apparatus at the same time. Therefore, it is possible to provide the state of the heads of the plurality of printers in an easy-to-view manner.

(Additional Note 2) In a second aspect that is a preferred example of the first aspect, the processing apparatus may cause the display portion to display the first state information and the second state information, and the third state information and the fourth state information in a distinguishable manner on one screen. In the above second aspect, in a state in which of the first recording apparatus and the second recording apparatus the head belongs to is distinguished, the state of each of the first head, the second head, the third head, and the fourth head can be visually notified to the user at once and at the same time.

(Additional Note 3) In a third aspect that is a preferred example of the second aspect, the processing apparatus may further cause the display portion to display boundary information indicating a boundary between the first state information and the second state information, and the third state information and the fourth state information. In the above third aspect, the first state information and the second state information regarding the first recording apparatus and the third state information and the fourth state information regarding the second recording apparatus can be visually and easily distinguished by the boundary information displayed on the display portion.

(Additional Note 4) In a fourth aspect that is a preferred example of the second aspect, the processing apparatus may cause the display portion to display the first state information and the second state information and the third state information and the fourth state information, with a difference in any one of a color, a font, and a size. In the above fourth aspect, the first state information and the second state information regarding the first recording apparatus and the third state information and the fourth state information regarding the second recording apparatus can be visually and easily distinguished by any of the colors, fonts, and sizes displayed on the display portion.

(Additional Note 5) In a fifth aspect that is a preferred example of the first or second aspect, the processing apparatus may be configured to switch between a first display mode in which the first state information, the second state information, the third state information, and the fourth state information are displayed so as to be emphasized to the same extent as each other, and a second display mode in which the first state information and the second state information are displayed so as to be emphasized compared to the third state information and the fourth state information. In the above fifth aspect, information necessary for the user can be changed by switching between the first display mode and the second display mode.

Here, in the first display mode, the first state information, the second state information, the third state information, and the fourth state information are displayed so as to be emphasized to the same extent as each other. Therefore, the first display mode is preferable when information on the states of both the first head and second head belonging to the first recording apparatus and the third head and fourth head belonging to the second recording apparatus is required. On the other hand, in the second display mode, the first state information and the second state information are displayed so as to be emphasized compared to the third state information and the fourth state information. Therefore, the second display mode is preferable when the information on the states of the third head and the fourth head belonging to the second recording apparatus is not required, but the information on the states of the first head and the second head belonging to the first recording apparatus is required.

(Additional Note 6) In a sixth aspect that is a preferred example of the fifth aspect, the processing apparatus may be configured to further switch a third display mode in which the third state information and the fourth state information are displayed so as to be emphasized compared to the first state information and the second state information. In the above sixth aspect, information necessary for the user can be changed by switching between the first display mode, the second display mode, and the third display mode. In the third display mode, the third state information and the fourth state information are displayed so as to be emphasized compared to the first state information and the second state information. Therefore, the third display mode is preferable when the information on the states of the first head and the second head belonging to the first recording apparatus is not required, but the information on the states of the third head and the fourth head belonging to the second recording apparatus is required.

(Additional Note 7) In a seventh aspect that is a preferred example of the first or second aspect, the first head and the third head may each eject ink of a first color, the second head and the fourth head may each eject ink of a second color different from the first color, and the processing apparatus may be configured to switch between a first display mode in which the first state information, the second state information, the third state information, and the fourth state information are displayed so as to be emphasized to the same extent as each other, and a fourth display mode in which the first state information and the third state information are displayed so as to be emphasized compared to the second state information and the fourth state information. In the above seventh aspect, by switching between the first display mode and the fourth display mode, regardless of whether the head belongs to the first recording apparatus or the second recording apparatus, information necessary for the user can be changed depending on the color of the ink used in the head.

Here, in the first display mode, the first state information, the second state information, the third state information, and the fourth state information are displayed so as to be emphasized to the same extent as each other. Therefore, the first display mode is preferable when, for each of the first recording apparatus and the second recording apparatus, the information on the heads of both the first color and the second color is required. On the other hand, in the fourth display mode, the first state information and the third state information are displayed so as to be emphasized compared to the second state information and the fourth state information. Therefore, the fourth display mode is preferable when, for each of the first recording apparatus and the second recording apparatus, the information on the state of the head using second ink is not required, but the information on the state of the head using first ink is required.

(Additional Note 8) In an eighth aspect that is a preferred example of the seventh aspect, the processing apparatus may be configured to further switch a fifth display mode in which the second state information and the fourth state information are displayed so as to be emphasized compared to the first state information and the third state information. In the above eighth aspect, by switching between the first display mode, the fourth display mode, and the fifth display mode, regardless of whether the head belongs to the first recording apparatus or the second recording apparatus, information necessary for the user can be changed depending on the color of the ink used in the head. Here, in the fifth display mode, the second state information and the fourth state information are displayed so as to be emphasized compared to the first state information and the third state information. Therefore, the fifth display mode is preferable when, for each of the first recording apparatus and the second recording apparatus, the information on the state of the head using first ink is not required, but the information on the state of the head using second ink is required.

(Additional Note 9) In a ninth aspect that is a preferred example of the first or second aspect, the processing apparatus may display the first state information in a different manner depending on whether an ejection state from the first head is normal or abnormal. In the above ninth aspect, the display of the first state information differs depending on whether the ejection state from the first head is normal or abnormal, and thus it is possible to notify the user whether or not the ejection state from the first head is normal, in other words, whether or not the ejection state from the first head is abnormal. By displaying the information on the other heads in the same manner, it is possible to notify the user whether the information on the other heads is normal or abnormal.

(Additional Note 10) In a tenth aspect that is a preferred example of the ninth aspect, the processing apparatus may display the first state information differently in a stepwise manner depending on a degree of abnormality in the ejection state from the first head. In the above tenth aspect, it is possible to notify the user of the degree of abnormality in the ejection state from the first head in a stepwise manner. Such a stepwise display is useful from a usability perspective because, for example, the user can take countermeasures in advance as needed or reduce the occurrence of periods during which the user cannot use the printer.

(Additional Note 11) In an eleventh aspect that is a preferred example of the first or second aspect, the processing apparatus may receive designation of the first head by a user and display first detailed state information indicating a state of the first head in more detail than the first state information based on the designation. In the above eleventh aspect, the user can ascertain detailed information regarding the first head as needed.

(Additional Note 12) In a twelfth aspect that is a preferred example of the first aspect, the ink jet system may further include a server configured to be connected to the processing apparatus, the server may acquire first information regarding use states of the first head, the second head, the third head, and the fourth head from the processing apparatus, and generate second information regarding the first state information, the second state information, the third state information, and the fourth state information based on the first information, and the processing apparatus may acquire the second information from the server, and cause the display portion to display the first state information, the second state information, the third state information, and the fourth state information based on the second information.

In the above twelfth aspect, it is possible to obtain the first state information, the second state information, the third state information, and the fourth state information by utilizing the knowledge of the administrator or the user of the server. Here, the administrator or the user of the server is the manufacturer of the head. Therefore, by utilizing the knowledge of the administrator or the user of the server, it is possible to accurately determine the state of the head, and then obtain the appropriate first state information, second state information, third state information, and fourth state information.

What is claimed is:

1. An ink jet system comprising:
a first recording apparatus in which at least a first head and a second head are mounted;
a second recording apparatus in which at least a third head and a fourth head are mounted; and
a processing apparatus that is commonly coupled to the first recording apparatus and the second recording apparatus and includes a display portion, wherein
the processing apparatus causes the display portion to display first state information indicating a state of the first head, second state information indicating a state of the second head, third state information indicating a state of the third head, and fourth state information indicating a state of the fourth head.

2. The ink jet system according to claim 1, wherein
the processing apparatus causes the display portion to display the first state information and the second state information, and the third state information and the fourth state information in a distinguishable manner on one screen.

3. The ink jet system according to claim 2, wherein
the processing apparatus further causes the display portion to display boundary information indicating a boundary between the first state information and the second state information, and the third state information and the fourth state information.

4. The ink jet system according to claim 2, wherein
the processing apparatus causes the display portion to display the first state information and the second state information and the third state information and the fourth state information, with a difference in any one of a color, a font, and a size.

5. The ink jet system according to claim 1, wherein
the processing apparatus is configured to switch between a first display mode in which the first state information, the second state information, the third state information, and the fourth state information are displayed so as to be emphasized to the same extent as each other, and a second display mode in which the first state information and the second state information are displayed so as to be emphasized compared to the third state information and the fourth state information.

6. The ink jet system according to claim 5, wherein
the processing apparatus is configured to further switch a third display mode in which the third state information and the fourth state information are displayed so as to be emphasized compared to the first state information and the second state information.

7. The ink jet system according to claim 1, wherein
the first head and the third head each eject ink of a first color,
the second head and the fourth head each eject ink of a second color different from the first color, and
the processing apparatus is configured to switch between a first display mode in which the first state information, the second state information, the third state information, and the fourth state information are displayed so as to be emphasized to the same extent as each other, and a fourth display mode in which the first state information and the third state information are displayed so as to be emphasized compared to the second state information and the fourth state information.

8. The ink jet system according to claim 7, wherein
the processing apparatus is configured to further switch a fifth display mode in which the second state information and the fourth state information are displayed so as to be emphasized compared to the first state information and the third state information.

9. The ink jet system according to claim 1, wherein
the processing apparatus displays the first state information in a different manner depending on whether an ejection state from the first head is normal or abnormal.

10. The ink jet system according to claim 9, wherein
the processing apparatus displays the first state information differently in a stepwise manner depending on a degree of abnormality in the ejection state from the first head.

11. The ink jet system according to claim 1, wherein
the processing apparatus receives designation of the first head by a user and displays first detailed state information indicating a state of the first head in more detail than the first state information based on the designation.

12. The ink jet system according to claim 1, further comprising:
a server configured to be connected to the processing apparatus, wherein
the server acquires first information regarding use states of the first head, the second head, the third head, and the fourth head from the processing apparatus, and generates second information regarding the first state information, the second state information, the third state information, and the fourth state information based on the first information, and
the processing apparatus acquires the second information from the server, and causes the display portion to display the first state information, the second state information, the third state information, and the fourth state information based on the second information.
